(19) United States
(12) Patent Application Publication
(10) Pub. No.: US 2018/0029304 A1
(43) Pub. Date: Feb. 1, 2018

(54) COMPOSITE BODY COMPRISING A DECORATIVE ELEMENT

(71) Applicant: D. Swarovski KG, Wattens (AT)

(72) Inventors: Uwe Pauli, Sevelen (CH); Thomas Wand, Schaan (LI)

(21) Appl. No.: 15/551,125

(22) PCT Filed: Feb. 4, 2016
(86) PCT No.: PCT/EP2016/000179

§ 371 Date: Aug. 31, 2017

(30) Foreign Application Priority Data
Feb. 16, 2015 (EP) 15000460.4

(51) Int. Cl. B29C 65/00; B32B 37/10; B32B 37/18; B32B 3/08; B32B 3/30; B32B 7/12; B32B 37/06; B32B 27/16; B32B 27/36; B32B 27/32; B32B 27/30; B29C 33/40; B29C 33/42; B29C 51/16; B29C 65/18; B32B 38/10; B29C 65/78; A44C 17/04; A45C 11/04; B44C 1/17; B44C 1/18; B32B 38/06

(52) U.S. Cl. CPC B29C 66/8432; B32B 38/06; B32B 37/10; B32B 37/182; B32B 3/085; B32B 3/30; B32B 7/12; B32B 37/06; B32B 27/16; B32B 27/365; B32B 27/32; B32B 27/302; B32B 27/306; B32B 27/308; B29C 33/405; B29C 33/424; B29C 51/16; B29C 65/18; B29C 66/474; B29C 66/1122; B29C 66/712; B29C 66/723; B29C 66/7392; B29C 66/74; B29C 66/8122; B29C 66/81264; B29C 66/81433; B29C 66/81457; B32B 38/10; B29C 66/032; B29C 65/7855; A44C 17/04; A45C 11/04; B44C 1/1729; B44C 1/18; B29K 2101/12

(57) ABSTRACT

A method for preparing a composite body (1) comprising a support body (2) and at least one decorative element (3), preferably a gemstone (3a, 3b), the support body (2) comprising a thermoplastic material, the method being characterized by the steps of:
arranging the decorative element (3) on the support body (2),
heating the support body (2),
pressing the decorative element (3) into the support body (2) by using a stamp (4) consisting of an elastically deformable material, the material of the stamp (4) being selected from the group of elastomers.

The present invention relates to a method for preparing a composite body comprising a support body and at least one decorative element, preferably a gemstone, the support body comprising a thermoplastic material.

Plastics—in particular, those made of thermoplastic material—can be used in a variety of areas of daily life, due to the plasticity and material properties thereof. One often-perceived disadvantage of plastics, however, is the surface finish thereof, such that it is frequently desired to decorate the surface of articles made of plastic with decorative elements, e.g., with gemstones. Because the decorative elements, e.g., in the case of gemstones made of glass, have completely different material properties from those of the plastic, it may prove awkward to fasten the decorative elements, especially since, on the one hand, it is extremely time-consuming to manually glue individual decorative elements and, on the other hand, so doing often only ensures an insufficient mechanical hold of the decorative elements.

For this purpose, the prior art already includes some known methods enabling improved mechanical hold and cost-effective and automatable manufacturing. European patent EP 2 432 632 relates to a method for preparing an article provided with gemstones, with the use of an injection molding machine with which the gemstones are held by a holding device comprising a support film, and back-molded with molten plastic. A disadvantage here is that the holding device must have been adapted to the gemstones to be applied. Moreover, the back-molding with molten plastic requires an injection molding machine, so that this method can only be used only a large industrial scale.

DE 2 452 250 describes a method for fastening gemstones to a support, the gemstones being arranged with coated setting surfaces in corresponding depressions in the support, fused together with the support in a tempering furnace at the melting temperature of the film on the support, and then cooled down. According to this method, thus, all of the gemstones may be provided with an adhesive layer prior to being fastened onto the support. This is a complex step that is not in line with enabling cost-efficient and automated manufacture.

EP 2 189 078 discloses a method for setting gemstones, in which depressions—which must correspond approximately to the dimensions of the gemstone—are drilled into the support body made of plastic. The support body is then heated in the region of the cavities, and the gemstones are placed in the cavities and pressed into the cavities so as to produce plastic deformation of the support around the gemstones. This method does ensure that the gemstones are mechanically securely fastened in the support body. However, this method is also cumbersome, time-consuming, and therefore also cost-intensive. Moreover, the support body needs to have at least a certain thickness in order for cavities to be mounted.

The present invention addresses the problem of providing a method that avoids the above disadvantages and offers a simple and flexible way to prepare a composite body comprising a support body—which is at least partially made of a thermoplastic material—and a decorative element.

The problem is solved by a method having the features of claim 1. Preferable embodiments of the invention are defined in the dependent claims.

In a first method step, the at least one decorative element is arranged on the support body, wherein the decorative element is arranged on the support body both manually and automatically, e.g., by means of a transfer film. Such a transfer film is especially helpful when a large number of decorative elements are to be arranged simultaneously on the support body. When a transfer film is being used, it may be appropriate to pre-fix the decorative element(s) on the support body in order to be able to peel the transfer film off of the decorative elements.

In another method step, the support body is heated, for example, by arranging the support body with the decorative element arranged thereon on a hot plate. Thermoplastics are plastics that can deform reversibly in a certain temperature range. As a result of the heating, the thermoplastic regions of the support body can achieve a pasty to molten-liquid state, whereby the thermoplastic material can have another spatial arrangement in the region of the arranged decorative element when pressure is applied onto the decorative element.

In another method step, the decorative element is pressed into the support body with a stamp made of an elastically deformable material. The support body may then be heated before or only after pressure has been applied to the stamp. The stamp made of an elastically deformable material makes it possible to fasten decorative elements of a variety of shapes and sizes—and, if there are a plurality of decorative elements, makes it possible to fasten same at a variety of distances to one another—on the support body, so that the stamp need not be specially adapted to different types of decorative elements. In particular, when a plurality of decorative elements are being fastened on the support body, then different types of decorative elements—in particular, having different sizes, shapes, and materials—may be pressed in simultaneously with the elastic stamp, wherein distances of different sizes can also be achieved between the decorative elements. Then, the size, shape, and distribution of the decorative elements on the support element may be largely discretionary, as long as the same pressure of the stamp can be applied thereto.

Depending on the elasticity of the stamp, the decorative element is enclosed to different degrees when the stamp is pressed in, wherein, depending on the selected hardness of the stamp and in accordance with the shape and size of the decorative element, it is possible to form, on the peripheral edge thereof, small cavities into which the pasty or molten liquid thermoplastic material of the support body can ascend so that, after the support body has been cooled and solidified, it is possible to stamp a staple-like, positive-locking setting for the decorative element. The size of this setting may be determined through appropriate selection of the temperature to which the support body is heated, the pressure and duration of application of pressure on the stamp, and the hardness of the stamp. In addition to the adhesive connection, such a positive-locking connection yields an especially secure hold for the decorative element.

Subsequently, the support body with the decorative element having been pressed in is cooled. This may be done, for example, by removing or switching off the heating plate or by replacing the heating plate with a cold plate. The method duration may then be controlled by the speed of the heating rate and the cooling rate as well as by the height of the temperature to which the support body is heated.

The decorative element is, for example, selected from among: a gemstone that is preferably provided with facets and that may be a natural or synthetic precious stone, or a gemstone made of ceramic material or a glass block, preferably made of crystal glass; a metallic decorative object; a wooden element; and the like.

The support body consists at least in regions—or, in one embodiment, even entirely—of a thermoplastic. Possible thermoplasts include ethyl vinyl acetates, polymethyl acrylates (PMMA), polycarbonates (PT), polyethylenes (PE), polypropylenes (PP), polystyrenes (PS), acrylonitrile butadiene styrenes (ABS), and the like.

In a preferred embodiment, the support body comprises a single-layer or multilayer thermoplastic film, or the support body consists of a single-layer or multilayer thermoplastic film. Such films are advantageous in being easily cut down to a certain size. A composite body consisting of a thermoplastic film having decorative elements fastened thereon may then be used, on the one hand, in an especially simple way to decorate other articles, for which purpose the elasticity and flexibility of such a film contribute significantly.

Then, the support body may comprise a film that is substantially transparent to light in the visible spectrum. For example, the thermoplastic film on which the decorative element is arranged is configured so as to be transparent to light in the visible spectrum. This is advantageous in that the positive-locking setting produced by the pressing in of the stamp enters optically into the background and interferes as little as possible with the appearance of the composite body. With multilayer films or a plurality of films, then, for example, the layer arranged on the upper side or the film arranged on the upper side, on which the decorative element is arranged, may be substantially transparent, whereas the layer lying thereunder would be substantially black. Depending on the desired appearance, the support body may be configured in general and the single- or multilayer films in particular, but in different colors and a variety of optical transmittance.

The material of the stamp is selected from the group of elastomers, wherein stamps made of silicone are especially suitable. The Shore hardness of the stamp may then be made in accordance with the material and the size of the decorative elements to be arranged, wherein the Shore hardness may be between A0 and A20. Stamps made of elastomers and, in particular, made of silicone are especially suitable for the method according to the invention, due to the ductility thereof. If the decorative element arranged on the support body is pressed in by the stamp into the support body, the stamp deforms around the decorative element and thus evenly exerts pressure on the decorative element, so that an even positive-locking connection between the support body and the decorative element can be produced. If removed from the composite body, the stamp takes shape again due to the elasticity, and can be used again for the method. Another advantage of silicone as the material for the stamp is the excellent release properties of silicone, so that the stamp is easy to remove after the decorative element has been pressed into the support body, without the risk of tearing the pressed-in decorative element back out from the support body.

Possible elastomers from which the stamp may be prepared are polyurethane rubber, polyurethane elastomers (TPU), polyester urethane rubber, natural rubber, and, in particular, silicone elastomers and silicone rubber.

In one embodiment of the method according to the invention, the surface of the stamp is provided with a structure that is imprinted into the thermoplastic material of the support body by the pressing step. When the decorative element is pressed into the molten liquid or pasty support body, the stamp is pressed directly onto the support body due to the ductility thereof in the regions outside of the decorative element. This causes the structure to be imprinted into the support body in this region, so that after the support body is cooled, a negative image of the structure of the stamp is produced in the composite body. In addition to the arrangement of the decorative elements, this is another step for improving the visual appearance of a composite body, wherein it is especially advantageous that the fastening of the decorative element, i.e., the gluing on or setting thereof, onto the support body and the imprinting of the surface structure of the stamp can be performed in a single process step. Then, there are nearly unlimited possibilities for the type and design of the structure that is imprinted into the support body, such that there are unique possibilities for designing a composite body having a support body and a decorative element arranged thereon or therein, especially because the type and number of the decorative elements, the setting pattern of the decorative elements, and the appearance of the surface of the support body between the decorative element(s) can be arbitrarily coordinated together due to the large number of adjustable method parameters, so that a complex, comprehensive visual design on a plurality of levels is made possible. The different imprinted surface structures serve as an integrated component of the design of the composite body according to the invention.

For example, the surface of the stamp with this preparation may be provided with a structure that approximates the surface of a textile fabric or the surface of different types of leather. Moreover, a variety of different geometric patterns—which, when the method according to the invention is carried out, are in turn imprinted as a negative image into the surface of the support body—may be imprinted into the surface of the stamp. In addition, images such as, for example, company logos that are depicted as a negative relief structure in the surface of the stamp may be transferred to the support body as a positive image.

In one embodiment of the method, the decorative element is arranged with a transfer film on the support body. The transfer film is then removed from the decorative element prior to the process of pressing in with the stamp. For this purpose, it may be necessary to pre-fix the decorative element on the support body. For this pre-fixing, the support body may also be heated, so that thermoplastic regions thereof become pasty or molten liquid. The decorative element is then lightly pressed into the support body, wherein the pressure acting on the decorative element is generally lower than the pressure applied to the elastically deformable stamp in order to press in and fasten the decorative element.

In one embodiment of the invention, the pre-fixing of the decorative element on the support body is performed by pressing on a stamp made of an elastically deformable material, wherein elastomers and, in particular, silicone are available as stamp materials. The stamp used for pre-fixing the decorative element may, however, also have a different Shore hardness than the stamp used for pressing in and fastening the decorative element. It may also, however, be provided to use only one type of stamp both to pre-fix the decorative element and to press in and fasten the decorative element in the support body. Due to the pre-fixing, the transfer film may then be peeled off without the risk of unintentionally removing the decorative element from the support body.

In one embodiment of the invention, that region of the support body in which the decorative element is arranged has a lower melting point than regions remote therefrom. If the support body, for example, comprises a multilayer thermoplastic film or consists of a plurality of films, then it may be provided that that layer of the thermoplastic film—or that film—on which the decorative element is arranged has a lower melting point than the layer or film remote therefrom. This causes only the outer edges of the thermoplastic film or only the outer film to become molten liquid or pasty when the support body is heated, whereas the inner regions or inner film(s) are only slightly affected. This is advantageous in that pushing of the decorative element through the entire support body can be avoided, because those regions of the support body that have a higher melting point are not molten liquid or pasty during the heating.

The present invention also relates to a method for decorating an article with a composite body that has been prepared according to a method such as is described above, wherein the support body is attached to the object with its side facing away from the decorative element. In particular, if the support body is configured to be flexible, e.g., comprises a thermoplastic film or consists of a thermoplastic film, the composite body may even be fastened onto complex-shaped three-dimensional bodies.

With this method, articles can thus be finished and decorated by the fastening of such a composite body. This method may be used especially advantageously when the support body consists of one or more thermoplastic films. The flexibility and elasticity of the film also makes it possible to cover complex-shaped three-dimensional bodies with the composite body, wherein the secure mechanical hold causes the decorative element to be securely fixed in the support body. Depending on the type of thermoplastic film, an elasticity of up to 30 to 40% in each pilling direction is possible (at room temperature), without putting the hold on the decorative element at risk.

The composite body may then be fastened onto textile fabrics, felt, or other plastic articles, wherein gluing or welding, sewing, and/or clipping are possible options. For example, the composite body may be fastened onto an endless hairband, headband, or armband in order to decorate same. Due to the ductility of the composite body in the circumferential direction, this method can be used to create a hairband, headband, or armband that has been decorated with a decorative element, without limiting the usability thereof. Then, a variety of different articles may also be refined later with this method. Examples of use include decorating covers for mobile telephones or tablets, and, in general, housings for a variety of electronic apparatuses, e.g., computer mice or loudspeakers, but also eyeglass cases, housings and pockets for tablets or laptops, and many more with such composite bodies.

Due to the simple method of preparation, a plurality of decorative elements can be set in an individually desired pattern, and then implemented in a composite body according to the invention. This composite body may then, in turn, be used to finish or decorate an article having an individual pattern.

The present invention also relates to a composite body comprising a support body and at least one gemstone, the support body comprising a thermoplastic material. Then, the composite body may have been prepared according to a method such as is described above. The composite body according to the invention is characterized in that a decorative relief is imprinted at least in regions on the side of the support body on which the gemstone is arranged. The relief is formed of the thermoplastic material of the support body. This creates a composite body that, in addition to the decoration from the at least one gemstone, has further design elements in the form of the decorative relief. The support body itself may comprise or consist of a single-layer or multilayer thermoplastic film. The relief-type structure may, as described above, be configured in the form of a geometric pattern or images, or even in the form of irregular patterns, such as modeled after, e.g., the surface of a textile fabric or a leather.

In a preferred embodiment, the support body is elastically deformable. Then, in the case of a flat support body, an elastic deformability per pulling direction of 30 to 40% may be achieved at room temperature.

In one embodiment of the present invention, the gemstone is configured as a chaton-shaped gemstone that is arranged with the back side—which converges to a point—in the support body, whereas the front side comprising the table projects entirely or at least in regions out of the support body .

In a preferred embodiment, the peripheral edge of the gemstone is enclosed at least in regions, preferably in an annular manner, by the thermoplastic material of the support body. This annular enclosure may engage in a clamping manner, as a bulge, around the greatest cross-sectional region of the gemstone, e.g., the girdle with a gemstone in the form of a chaton, producing an especially stable fastening of the gemstone on the support body.

The structure of the stamp is configured as a relief on the stamp surface, and may constitute, for example, a geometric pattern, an image, or even an irregular pattern, such as modeled on, for example, the surface of a textile fabric or a leather.

An additional visual effect may be that the surface of the support body on which the decorative element is arranged is printed, for example, in the form of a printed film. Because a synthesis of three-dimensional appearance due to the relief-type structure, the visual impression of the printed surface of the support body, and the support effect from the decorative element occurs, and thus impressive, unique visual effects can be achieved.

### Further details and advantages of the present invention are described in greater detail hereinbelow, on the basis of the description of the figures in reference to the drawings. In the drawings,

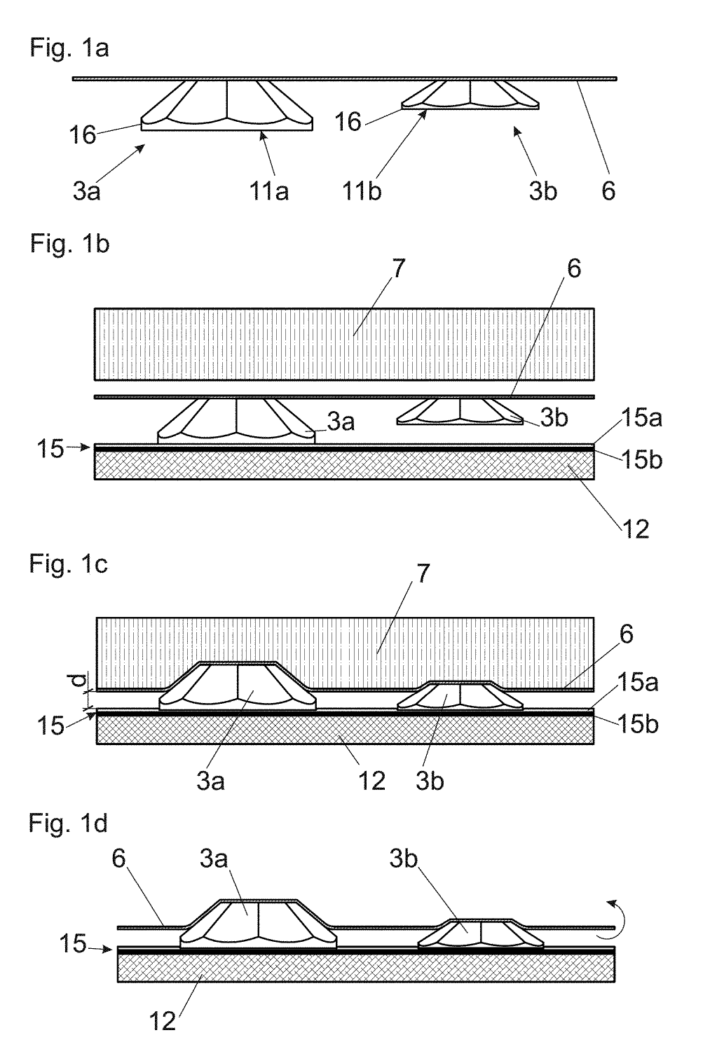

FIGS. 1a to 1d illustrate schematic representations of the arrangement of two differently configured decorative elements on a support body;

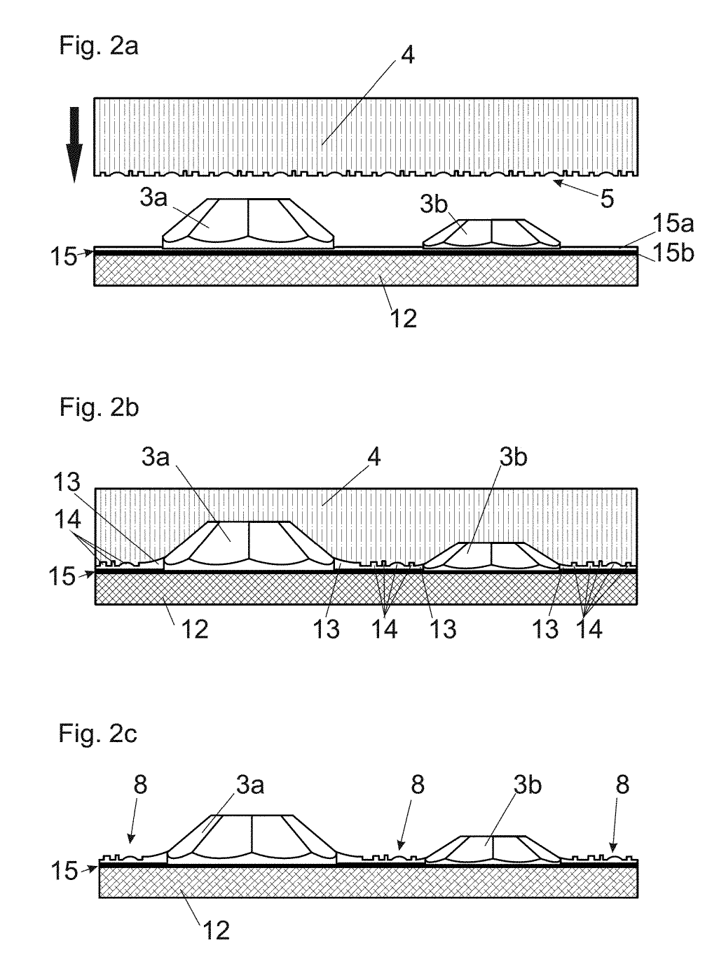

FIGS. 2a to 2c illustrate schematic representations of the method step of pressing the decorative elements in with a stamp made of an elastically deformable material;

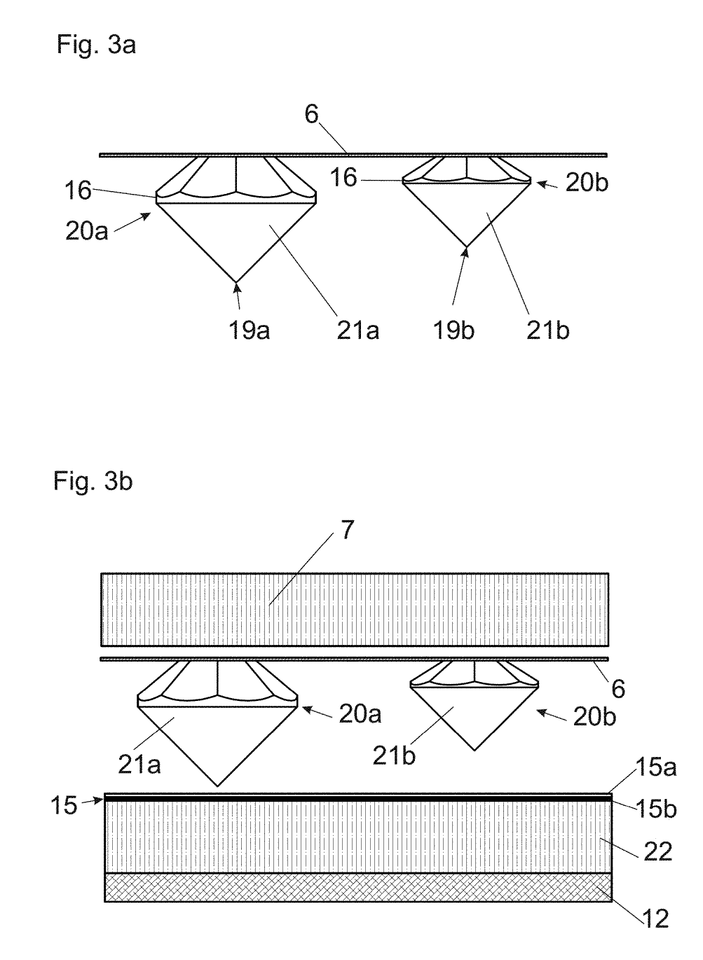

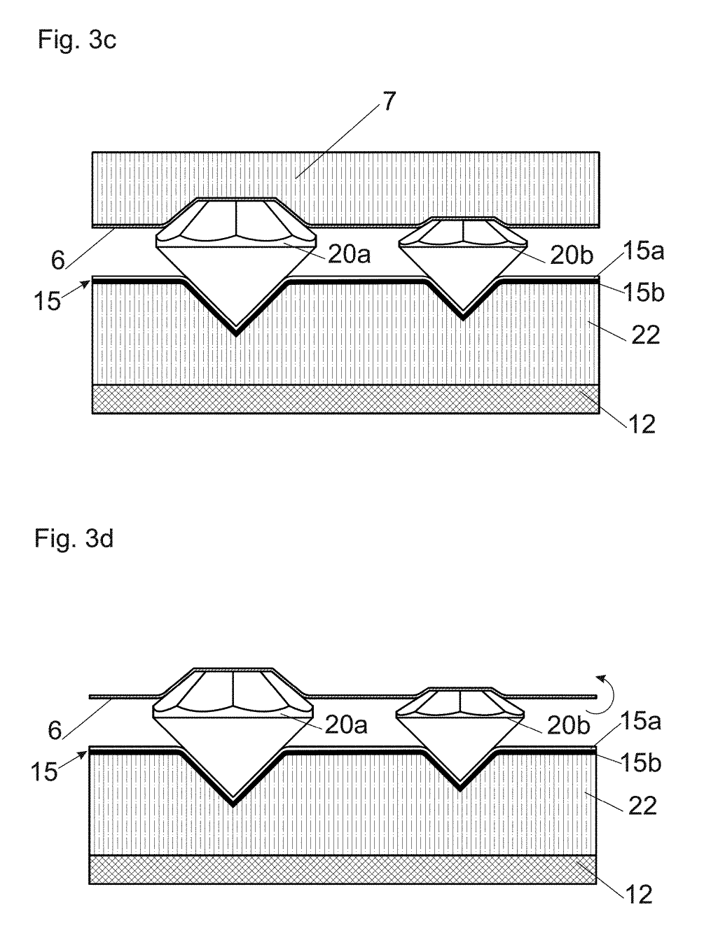

FIGS. 3a to 3d illustrate schematic representations of the arrangement of two differently configured decorative elements on a support body, the decorative elements being chaton-shaped gemstones;

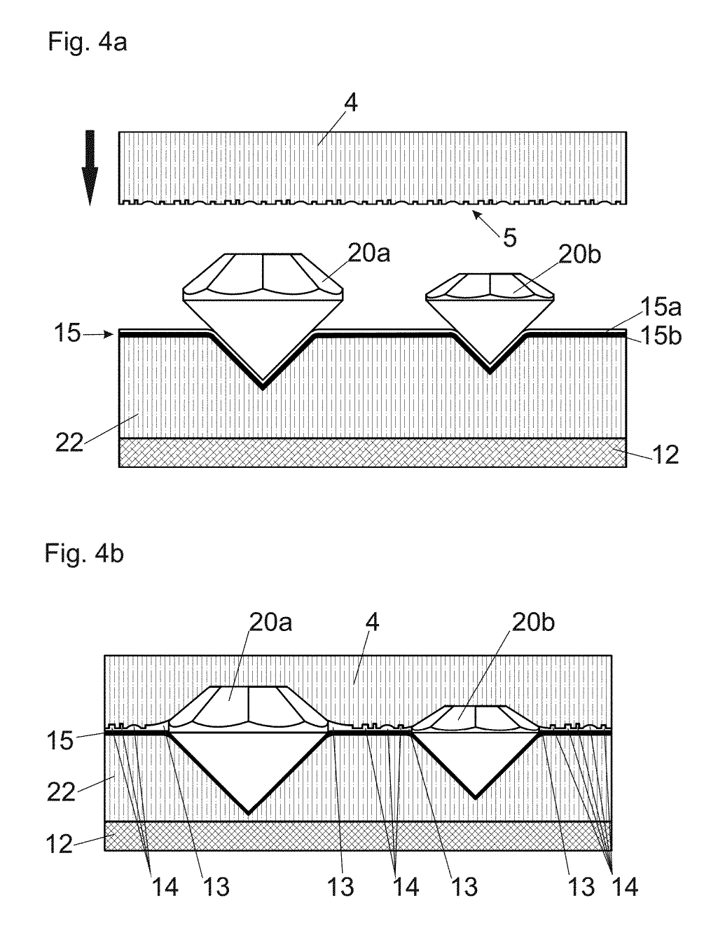

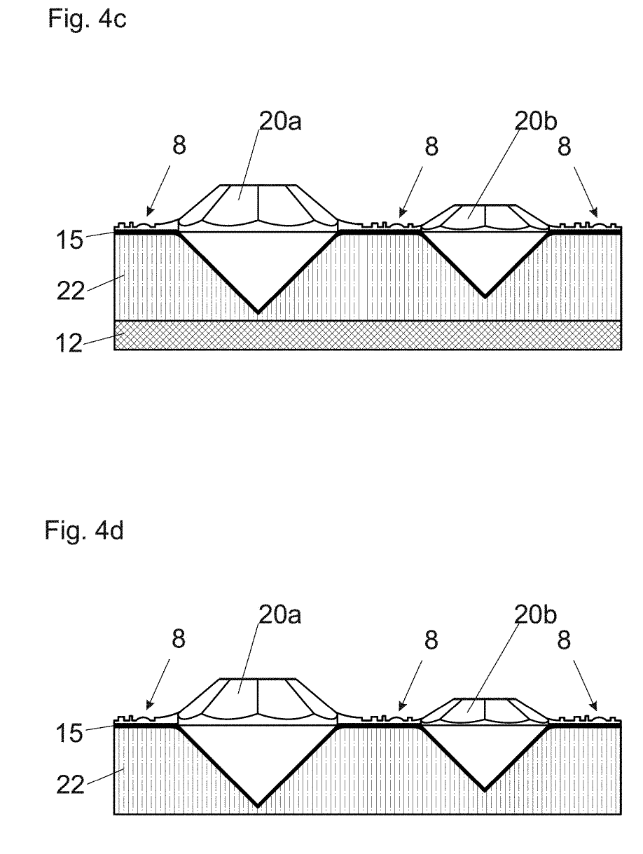

FIGS. 4a to 4d illustrate schematic representations of the method step of pressing the decorative elements in with a stamp made of an elastically deformable material, the decorative elements being chaton-shaped gemstones;

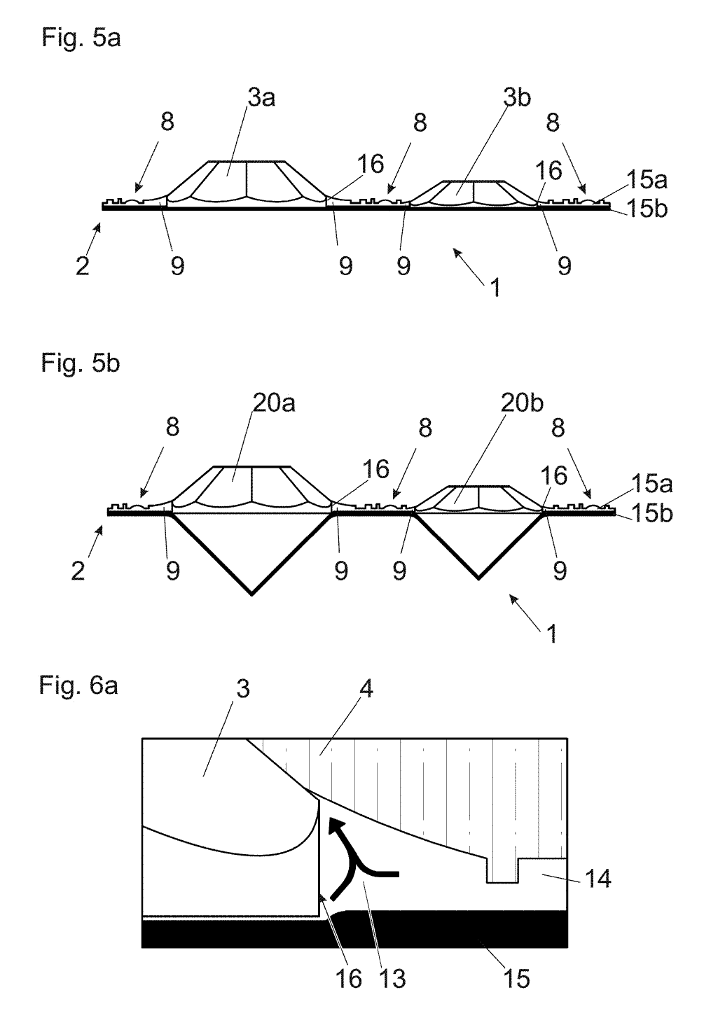

FIGS. 5a and 5b illustrate composite bodies according to the invention,

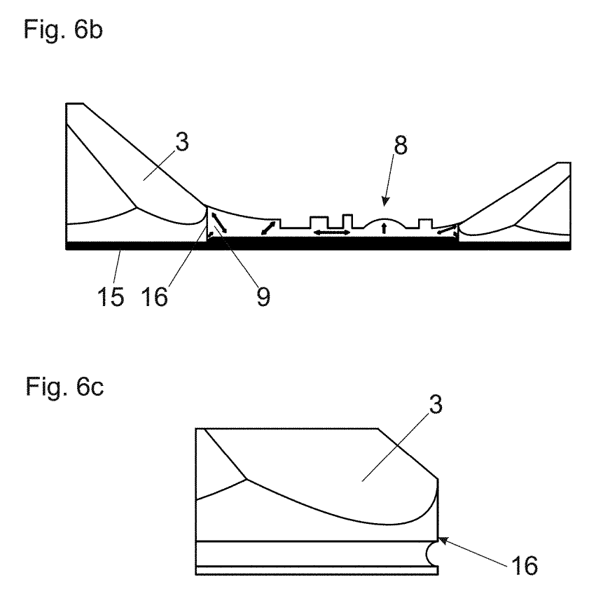

FIGS. 6a to 6c illustrate schematic representations of the production of a setting for the decorative element with the method according to the invention;

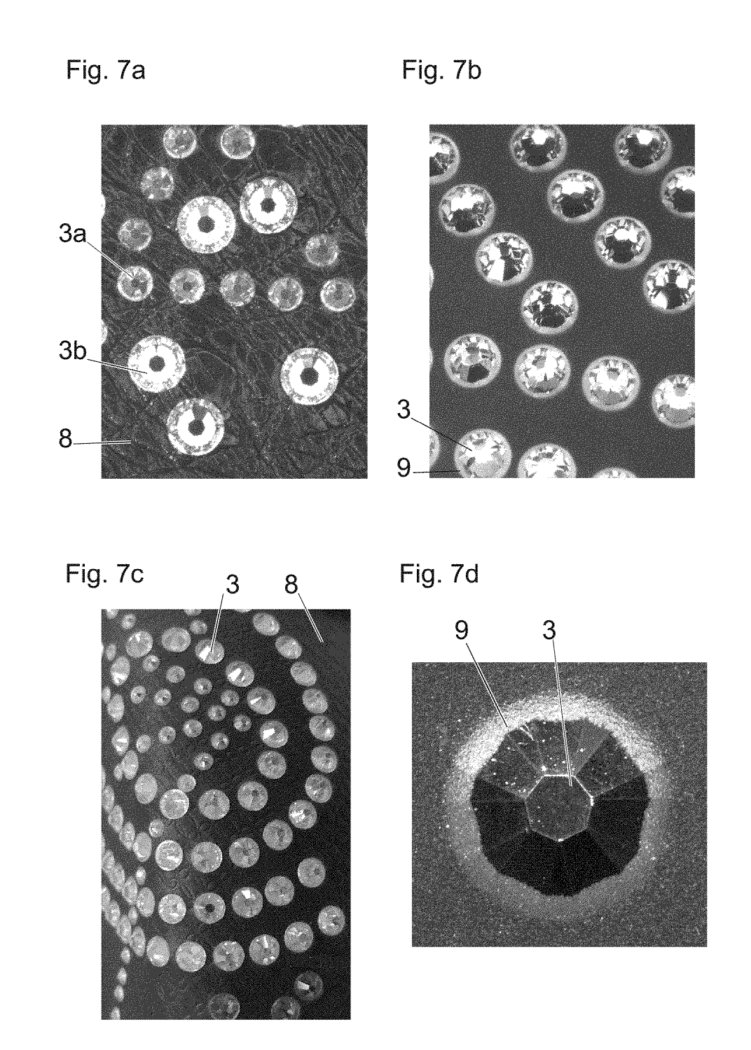

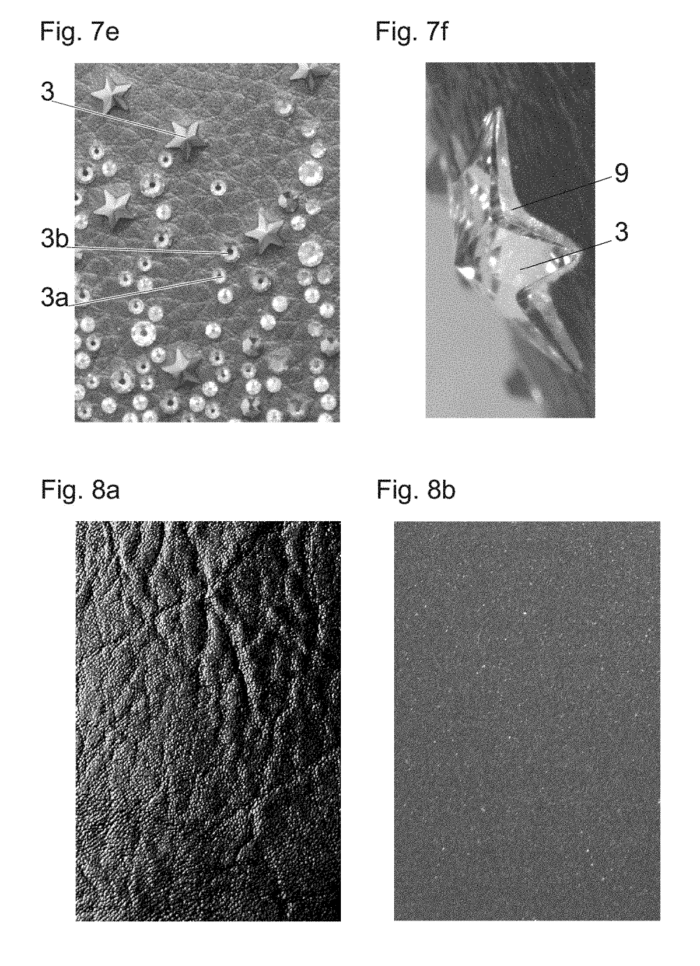

FIGS. 7a to 7f illustrate photographs of composite bodies having decorative elements that have been set in support bodies;

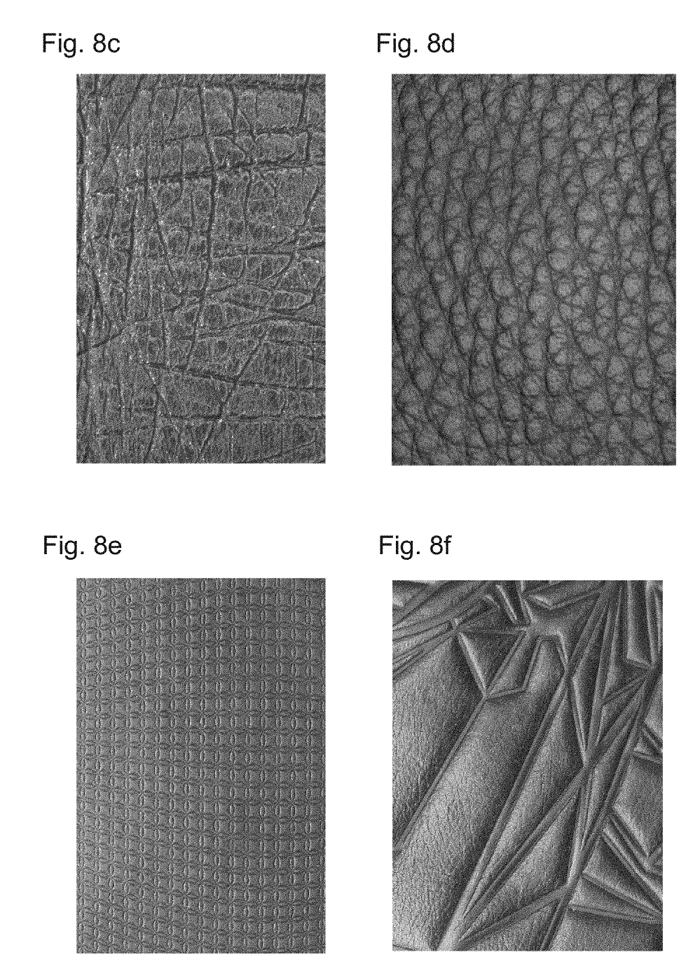

FIGS. 8a to 8f illustrate photographs of different embodiments of the structure imprinted in the composite body;

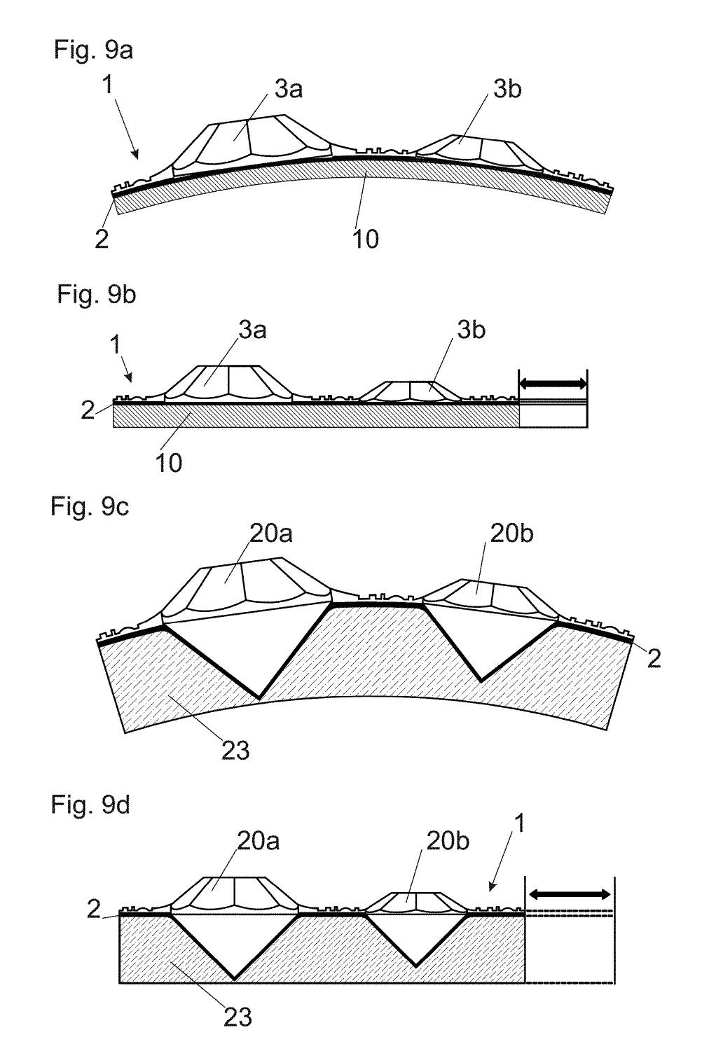

FIGS. 9a to 9d illustrate schematic representations of the flexible deformability of a composite body according to the invention;

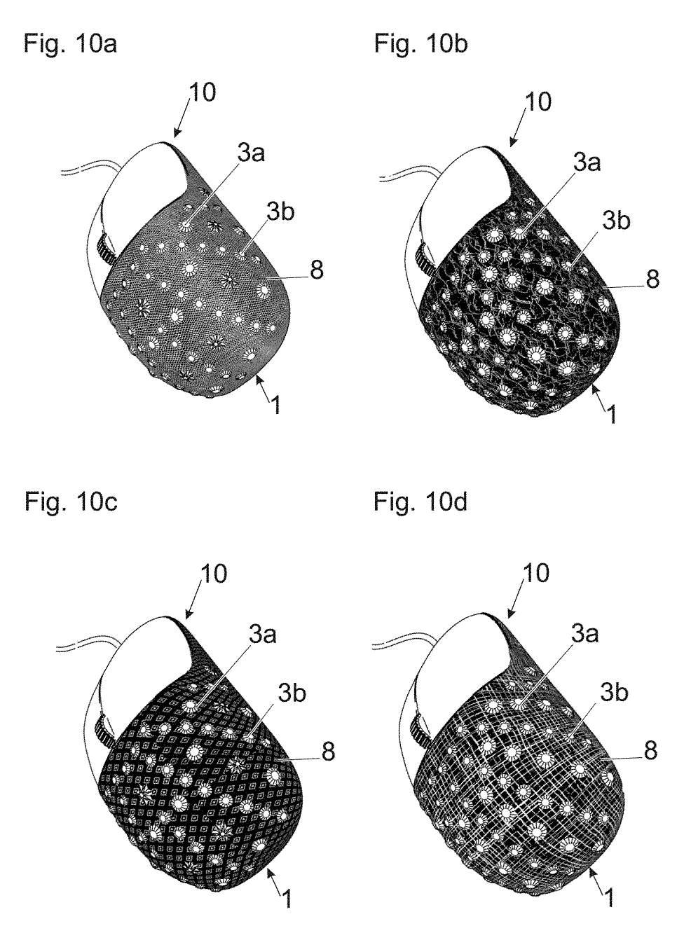

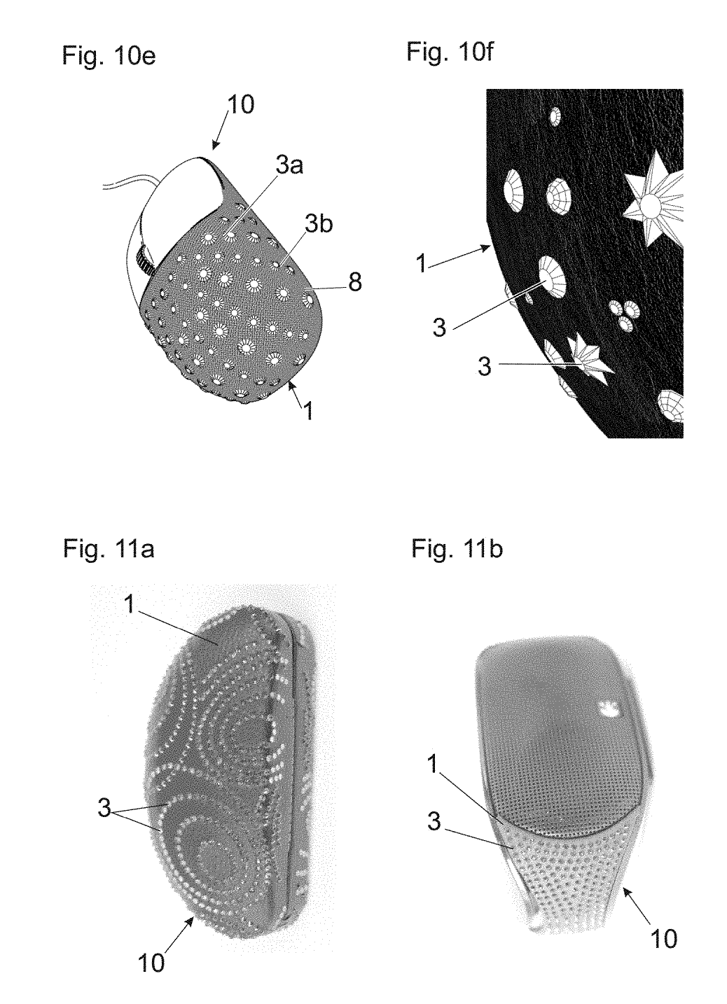

FIGS. 10a to 10f illustrate examples of articles that have been decorated with a composite body according to the invention, and a detail view thereof; and

FIGS. 11a and 11b illustrate photographs of articles that have been covered with a composite body according to the invention.

In the case of a plurality of decorative elements, a design template in terms of the set pattern for the decorative elements may be created in advance, wherein a setting machine can be used for automation.

For the preparation of a stamp 4 provided with a structure 5, first, the positive image of the structure 5 is set. If, for example, a stamp 4 made of silicone with which the surface of a composite body 1 according to the invention is to be modeled after the appearance of an artificial leather surface is to be prepared, then the artificial leather is stretched in a frame and fixed so that silicone poured into the frame cannot flow out. The size of the frame depends on the size of the stamp 4, which depends in turn on the size of the decorative elements 3 that are to be pressed into the support body 2 with the stamp 4. This frame also prevents the silicone from being displaced laterally during the pressing process.

With this process, it is possible to mold a variety of structure positives, by means of the stamp, into the composite body 1, such as, for example, surfaces that have been geometrically structured or imprinted with an image, or even randomly structured surfaces, such as leather surfaces, sand paper, and the like.

With a stamp 4 made of silicone, it is possible to use silicones in the Shore hardnesses A0 to A15, such as, for example, Wacker® silicones, Elastosil® RT 623 A/B with silicone oil, Wacker® AK 35, or Elastosil® M 4511 with curing agent T51.

FIG. 1a depicts how two gemstones 3a, 3b of different sizes that have a flat back side 11a, 11b are arranged on a transfer film 6. The back sides 11a, 11b serve as contact surfaces for the support body 2. One possible example for the transfer film 6 is a silicone adhesive transfer film from the company Nagel & Hermann (silicone glue, intensity adhesive with ripple film). The size, shape, and distances of the gemstones 3a, 3b are largely freely selectable. The decorative elements 3 may then be applied mechanically or manually. Alternatively, it would also be possible to arrange the decorative elements 3 directly on the support body 2.

As is schematically represented in FIG. 1b, the transfer film 6 moved with the gemstones 3a, 3b arranged thereon to the support body 2, which is arranged on a still-cold heating plate 12. In this embodiment, the support body 2 is consists of a two-layered thermoplastic film 15, optionally supplemented by a support film. The gemstones 3a, 3b are set with the flat back sides 11a, 11b on the thermoplastic film 15. Above the transfer film 6, a stamp 7 made of an elastically deformable material is set onto the gemstones 3a, 3b. In this embodiment, the stamp 7 is also made of silicone. The stamp 7 does not have a structure for imprinting into the support body 2. The stamp 7 for the pre-fixing may then have a Shore hardness between A0 and A30.

In this embodiment, the support body 2 is configured as a two-layered film 15 having a polyurethane melt film 15a and a support film 15b. Possible examples of such support bodies 2 configured as films 15 are the transparent three-layered film Nr. 963344 and the black two-layered film Nr. 963347 from the company Callan0® Adhesive. Alternatively, polyamides (PA), polyethylene (PE), amorphous polyalphaolefin (APAO), polyester elastomers (TPE-E), polyurethane elastomers (TPE-U), or copolyamide elastomers (TPE-U) may be used for the thermoplastic film 15 or the thermoplastic support body 2.

As mentioned above, decorative elements of different sizes, shapes, and colors can be used for the method according to the invention. In particular, gemstones 3a, 3b having flat back sides may be used, but so too may chaton-shaped gemstones 20a, 20b. If decorative elements 3 made of different elements are used, it is assumed that these decorative elements 3 are resistant to temperatures above the melting point of the thermoplastic material.

FIG. 1c depicts how the gemstones 3a, 3b are pre-fixed on the thermoplastic film 15, in order to subsequently allow for the transfer film 6 to be removed from the gemstones 3a, 3b. First, light pressure is applied to the stamp 7. The pressure must be so strong that the gemstones 3a, 3b are readily pressed into the thermoplastic film 15. A continuous press or a plate press can be used for applying the pressure. One possible example is a flatbed laboratory vulcanizing press KWS VP 320 from the company KWS Kachele GmbH. With large-scale industrial manufacturing, for example, flatbed laminating installations from the company Firma Maschinenfabrik Herbert Meyer GmbH may be used.

Subsequently, in this embodiment, the heating plate 12 is heated to a temperature between 120° C. and 160° C., the pressure on the stamp 7 being maintained. In the embodiment depicted, the distance d between the stamp 7 and the thermoplastic film 15 is between 0.2 and 0.5 mm.

After the melting point of the thermoplastic film 15 has been reached, the heating of the heating plate 12 is stopped, so that the film 15 can cool. The pressure on the stamp 7 is held constant. At a temperature of around 80° C., the silicone stamp 7 is removed and the transfer film 6 is peeled off. This is illustrated schematically in FIG. 1d, with reference to the curved arrow.

For the pressing in of the gemstones 3a, 3b into the support body 2 in order to finally fasten same, the support body 2 is positioned with the pre-fixed gemstones 3a, 3b on the cold heating plate 12 in the press. The stamp 4, which consists of silicone in this embodiment as well, is pressed in a coplanar manner onto the support body 2 when the press is closed (cf. FIG. 2a). The stamp 4 has a structure 5 of which a negative copy is imprinted in the support body 2 due to the pressing operation. The stamp 4 may have a thickness between 3 and 10 mm, just as the stamp 7 may. If no structure is to be imprinted into the composite body 1, the stamp 7 that is used to pre-fix the gemstones 3a, 3b may also be used for the pressing in of the gemstones 3a, 3b in this method step.

Pressure is then applied to the stamp 4. This is depicted in FIG. 2b. Then, the pressure depends on the size of the decorative elements 3 and the Shore hardness of the stamp 4. In this embodiment, the pressure amounts to p=25 kN. The lateral displacement of the silicone can be prevented by the use of a frame, which is not shown in FIGS. 2a and 2b in order to preserve the clarity. As a result of the application of pressure, the elastically deformable stamp 4 fits snugly around the gemstones 3a and 3b. However, the stamp 4 has only a limited malleability, so that cavities 13 form at the rim of the gemstones 3a, 3b. More cavities 14 form with the relief-type structure 5 of the stamp.

The pasty or molten liquid thermoplastic material of the support body 2 is pressed into these cavities 14, whereby the relief-type structure 8 of the support body 2 and the settings 9 for the decorative elements 3 subsequently form. Then, the heating plate 12 is heated to a temperature between 120° C. and 160° C., until the melting temperature of the thermoplastic film 15 is achieved, and is held at this temperature for a holding time that, in this embodiment, amounts to between 1 and 3 minutes. Then, pressure is always applied to the stamp 4. The holding time depends on the size of the decorative elements 3. During this method step, the cavities 13 on the peripheral edge 16 of the gemstones 3a, 3b and the cavities 14 that occur due to the structure 5 are filled with plasticized thermoplastic material of the support body 2. Under application of pressure, the heating plate 12 is switched off and cooling is preferred to a temperature of about 80° C. Thereafter, the stamp 7 is removed and the finished composite body 1 having fixed gemstones 3a, 3b and decorative relief 8 is taken out of the press. This is depicted in FIG. 2c.

With the method according to the invention, decorative elements 3 having a side that converges into a point may also be arranged in the support body 2. The necessary adaptations of the method shall be described by way of example, on the example of two chaton-shaped gemstones 20a, 20b of different sizes. Chaton-shaped gemstones 20a, 20b consist of a front side having a flat table and a back side 21a, 21b having a tip 19a, 19b. The tip 19a, 19b is inserted into the support body 2, so that the front side with the table projects at least partially out of the support body 2. If chaton-shaped gemstones 20a, 20b having a transfer film 6 are arranged on or in the support body 2, the gemstones 20a, 20b are arranged with the flat table on the transfer film 6. Then, a precise alignment is required, so that the longitudinal direction of the chaton-shaped gemstone 20a, 20b is aligned perpendicularly on the transfer film 6. FIG. 3a depicts how two chaton-shaped gemstones 20a, 20b of different sizes are arranged on a transfer film 6.

When the chaton-shaped gemstones 20a, 20b are used, unlike the embodiment according to FIGS. 1 and 2, the thermoplastic film 15 is not laid directly on the heating plate 12, but on a protective plate 22, e.g., a silicone plate, which may have the same Shore hardness as the stamp 7. The pressure on the stamp 7 must be so strong that the tip of the chaton-shaped gemstones 20a, 20b is readily pressed into the melt film 15. For this embodiment, the stamp 7 for pre-fixing the gemstones 20a, 20b need not have a relief-type structure, or only a very slight relief-type structure, so as to influence as little as possible the position and orientation of the chaton-shaped gemstones 20a, 20b. FIG. 3b, depicting this process, corresponds substantially to FIG. 1 b, wherein a protective plate 22 such as is described above is arranged under the multilayer thermoplastic film 15a, 15b, due to the chaton-shaped gemstones 20a, 20b having a tip 19a, 19b, the protective plate being arranged in turn on the heating plate 12.

The method steps schematically illustrated in FIGS. 3c and 3d correspond to the method steps described in connection with FIGS. 1c and 1d, so that reference may be made to the relevant passages.

In the case of a support body 2 consisting of a thermoplastic film 15, when the method is used for chaton-shaped gemstones 20a, 20b, the film 15 must be placed on a protective plate 22, e.g., made of silicone, during the pressing process as well, such as is depicted in FIGS. 4a to 4d. The protective plate 22 may then have approximately the same Shore hardness as the stamp 4. The resulting composite body 1 may, depending on this thickness of the support body 2, have a relief-type underside due to the pressing in of the tip 19a, 19b. This relief-type underside can be flattened, e.g., by application of a suitable material from below, until a flat surface is created.

Therein, the method steps depicted schematically in FIGS. 4a to 4c correspond substantially to those of FIGS. 2a to 2c, wherein, however, the gemstones 20a, 20b are pressed into the protective plate 22 together with the thermoplastic film 15 due to the tip 19a, 19b of the chaton-shaped gemstones 20a, 20b. It may then be provided that the protective plate 22 is a component of the support body 2, in which, for example, the film 15 is adhered with the protective plate 22, such as is depicted in FIG. 4d. It may, however, also be provided that the protective plate 22 is again removed from the support body 2 after the decorative elements 3 have been pressed in.

FIG. 5a depicts a composite body 1 according to the invention, with which gemstones 3a and 3b of different sizes have been fastened onto the support body 2, wherein the support body 2 in this case consists of a thermoplastic film 15 having layers 15a and 15b. The composite body 1 has a relief-type structure 8 in the regions outside of the gemstones 3a, 3b. Then the peripheral edge 16 of the gemstones 3a, 3b is set by the setting 9 made during the pressing process. Then, the gemstones 3a, 3b are held in a positive-locking manner on the support body 2. This setting 9 considerably reinforces the adhesive adherence. Depending on the configuration of the edge region of the decorative elements 3, the setting 9 may encircle the peripheral edge 16 in an annular manner, producing an especially stable fastening.

FIG. 5b depicts a composite body 1 with which, in contrast to FIG. 5a, the gemstones 20a, 20b are chaton-shaped.

FIGS. 6a to 6c illustrate schematically how the setting 9 and the structure 8 are made during the pressing process. First the decorative element 3 is arranged on the support body 2. Then, the stamp 4 is placed on the decorative element 3, and pressure is applied thereto. The stamp 4 then does fit snugly onto the decorative element 3, due to the elastic deformability thereof. Due to the limited malleability of the stamp 4, there occurs a cavity 13 around the peripheral edge 16 at the foot of the decorative element 3. When the melting temperature is reached, the thermoplastic material of the support body 2 begins to become molten liquid or pasty, whereby thermoplastic material from the support body 2 rises up and fills the cavity 13, as is depicted with the arrows in FIG. 6a. After the cooling, a positive-locking connection is formed. Similarly, the thermoplastic material flows into the cavities 14 that arise with the structured regions 5 of the stamp 4. This is illustrated in the schematic representation of FIG. 6b, with reference to the arrows.

A suitable geometry of the peripheral edge 16 of the decorative element 3 makes it possible to optimize the mechanical connection between the decorative element 3 and the support body 2. FIG. 6c illustrates one example of a positive lock-optimized design of the peripheral edge 16 of the decorative element 3.

FIGS. 7a to 7f illustrate photographs of sections of embodiments of the composite bodies 1 according to the invention. FIG. 7a illustrates a section of a composite body 1 with which a plurality of gemstones 3a, 3b of different sizes have been set in a random arrangement in a support body 2. The structure 8 between the set gemstones 3a, 3b is easily recognizable and, in this example, imitates the surface of ostrich leather.

FIG. 7b depicts a photograph of another embodiment of a composite body 1 according to the invention, wherein the setting 9 surrounds the peripheral edge 16 of the decorative elements 3, configured as gemstones, and thereby provides an especially stable mechanical hold.

FIG. 7c, in turn, depicts a section of a composite body 1 with which the imprinted structure 8 constitutes a geometric pattern. In the detailed view of FIG. 7d, the setting 9s is especially visible. The peripheral edge 16 of the decorative element 3, configured in the form of a gemstone, is surrounded thereby. In this case, the support body 2 comprises a multilayer thermoplastic film 15, wherein the outermost film 15a is configured so as to be substantially transparent to light in the visible spectrum, so that the setting 9 has the least possible effect on the brilliance through the gemstone.

FIG. 7e depicts another photograph pertaining to a section from a composite body 1 according to the invention, in which—in addition to gemstones 3a, 3b of different sizes—star-shaped decorative elements 3 are also arranged in a support body 2, wherein a structure 8 that imitates a leather surface has been imprinted into the support body 2. The detailed view according to FIG. 7f illustrates how the setting 9 is arranged around the rim of the star-shaped decorative element, and ensures a particularly stable hold.

FIGS. 8a to 8f illustrate photographs of different embodiments of the structure 8 imprinted into the composite body 1, wherein the structure 8 according to FIGS. 8a and 8b imitates the surfaces of two different textile fabrics, whereas the structure according to FIG. 8c imitates the surface of ostrich leather, and the structure 8 according to FIG. 8d illustrates the surface of calfskin. In FIGS. 8e and 8f, a geometric pattern is imprinted as a structure 8 into the surface of the composite body 1. There are many design possibilities.

FIGS. 9a to 9d illustrate the advantages of a composite body 1 in which the support body 2 consists of a thermoplastic film 15. In FIG. 9a, the composite body 1 is to be affixed onto a curved or flexible article 10, for example, a computer mouse or a handbag. Due to the flexibility of the thermoplastic film 15 and the secure hold on the decorative elements 3a, 3b, it is possible to use the composite body 1 to decorate articles 10 that have a variety of shapes and are even themselves flexible.

Similarly, FIG. 9b illustrates how the elastic article 10, which is provided with a composite body 1 consisting of a thermoplastic film 15 having decorative elements 3a, 3b fastened therein can be stretched by about 30 to 40% at room temperature without losing the decorative elements 3a, 3b.

FIGS. 9c and 9d are similar to FIGS. 9a and 9b, with the difference that the decorative elements 3 are configured as chaton-shaped gemstones 20a, 20b and are embedded with the tips 19a, 19b thereof and the support film 15 in a protective layer 23 made of a flexible material, thereby preventing the gemstones 20a, 20b from being pushed out. As the protective layer 23, for example, the protective plate 22 may be provided.

FIGS. 10a to 10e depict computer mice 10 having a rear region that has been covered in each case with a composite body 1 according to the invention, wherein adaptation to the surface of the computer mice 10 is readily possible due to the elastic properties of the support body 2. Then, there is no danger of losing the decorative elements 3, due to the extremely stable hold of the decorative elements 3 in the support body 2. In the case of the computers mice 10 depicted in FIGS. 10a to 10e, a plurality of decorative elements 3 are respectively arranged in the form of gemstones 3a, 3b of different sizes. The embodiments differ from one another in the relief-type structure 8 that is imprinted into the composite body 1. Whereas geometric patterns are imprinted in FIGS. 10c and 10d, the surface of a leather or a textile fabric is imitated in FIGS. 10a, 10b, and 10e.

In another embodiment, the detailed view of FIG. 10f illustrates a composite body 1 that is arranged on an article 10, wherein a variety of decorative elements 3—in the form of gemstones, but also bodies 3 configured so as to be star-shaped—are arranged in the composite body.

FIG. 11a depicts a photograph of an eyeglass case 10, the housing of which is covered with a composite body 1 that consists of a flexible support body 2 having a plurality of gemstones 3 arranged therein.

FIG. 11b depicts a photograph of a loudspeaker 10 having a housing that is covered on one side with a composite body 1, in which a plurality of gemstones 3 have been set in a regular arrangement.

1. A method for preparing a composite body comprising a support body and at least one decorative element, wherein the support body comprises a thermoplastic material, the method being characterized by the steps of:
arranging the decorative element on the support body,
heating the support body,
pressing the decorative element into the support body using a stamp made of elastically deformable material, wherein the material of the stamp is selected from the group of elastomers.

2. The method according to claim 1, wherein the support body comprises a single-layer or multilayer thermoplastic film or consists of a single-layer or multi-layer thermoplastic film.

3. The method according to claim 2, wherein the support body comprises a film that is substantially transparent to light in the visible spectrum.

4. The method according to claim 1, wherein the surface of the stamp is provided with a structure that is imprinted into the thermoplastic material of the support body by the pressing step.

5. The method according to claim 1, wherein the decorative element is arranged with a transfer film on the support body.

6. The method according to claim 1, wherein the decorative element is pre-fixed on the support body by pressing onto the support body with a stamp made of elastically deformable material.

7. The method according to claim 6, wherein the stamp for the pre-fixing is also used for pressing of the decorative element.

8. The method according to claim 1, wherein that region of the support body in which the decorative element is arranged has a lower melting point than regions of the support body that are remote therefrom.

9. The method according to claim 1, wherein the side of the support body facing away from the decorative element is attached to an article.

10. A composite body comprising a support body and at least one gemstone, wherein the support body comprises thermoplastic material, and wherein the composite body is prepared, by arranging a decorative element on the support body, heating the support body, and pressing the decorative element into the support body using a stamp made of elastically deformable material, wherein the material of the stamp is selected from the group of elastomers, characterized in that a decorative relief is imprinted at least in regions on the side of the support body on which gemstone is arranged.

11. The composite body according to claim 10, wherein the support body is elastically deformable.

12. The composite body according to claim 10, wherein the peripheral edge of the gemstone is enclosed at least in regions, preferably in an annular manner, by the thermoplastic material of the support body.

13. The composite body according to claim 10, wherein the gemstone is a chaton-shaped gemstone is a chaton-shaped gemstone the back side of which, converging into a tip, is arranged in the support body.

14. The method according to claim 1, wherein the at least one decorative element is a gemstone.

15. The composite body according to claim 10, wherein the support body comprises a single-layer or multilayer thermoplastic film or consists of a single-layer or multi-layer thermoplastic film.

16. The composite body according to claim 15, wherein the support body comprises a film that is substantially transparent to light in the visible spectrum.

17. The composite body according to claim 10, wherein the edge of the gemstone is enclosed in an annular manner.

18. Apparatus for making a composite body, the apparatus comprising a plurality of gemstones, a support body comprising a thermoplastic material, and a stamp for pressing the gemstones into the support body, the stamp made of an elastically deformable material, wherein the material of the stamp is selected from the group of elastomers.

19. The apparatus of claim 18, wherein the stamp comprises a relief-type structure.

20. The apparatus of claim 18, wherein the surface of the surface of the stamp is provided with a structure that is imprinted into the thermoplastic material of the support body.
